(19) United States
(12) Patent Application Publication
(10) Pub. No.: US 2022/0358437 A1
(43) Pub. Date: Nov. 10, 2022

(54) SUPPLY CHAIN MANAGEMENT SYSEM AND PLATFORM WITH FEATURES FOR MILESTONE AND DATA CALCULATIONS

(71) Applicant: Target Brands, Inc., Minneapolis, MN (US)

(72) Inventors: Michael Rorro, Minneapolis, MN (US); Moid Alwy, Minneapolis, MN (US); Daniel J. Johnson, Minneapolis, MN (US); John Evers, Minneapolis, MN (US); Alex Bliss, Minneapolis, MN (US); Jesse Sprinkel, Minneapolis, MN (US)

(73) Assignee: Target Brands, Inc., Minneapolis, MN (US)

(21) Appl. No.: 17/313,289

(22) Filed: May 6, 2021

(51) Int. Cl. G06Q 10/06; G06Q 10/08

(52) U.S. Cl. CPC G06Q 10/06315; G06Q 10/08355

(57) ABSTRACT

Order data specifies one or more items to be purchased from one or more source locations in a supply chain for a destination location. One or more constraints are received for the order in the supply chain. Travel path are determined for the item to reach the destination location, the travel path defining a plurality of facilities and a plurality of travel legs that together define a travel path for the item to be shipped from a source location to a destination location. One or more milestones for the travel path are selected based on the constraints. One or more other milestones for the travel path are selected based on the constraints. One of the milestones is an inventory readiness date that specifies a first calendar date on which an order of items should be ready at each items' respective destination location.

### TECHNICAL FIELD

This document generally relates to technology for supply chain management, including technology for tracking freight in transit through a supply chain.

### BACKGROUND

Supply chains are, in general, complex networks through which goods are supplied from producers to retailers and, ultimately, consumers. For example, supply chains can involve many different producers that are generating products for distribution, each of which may emanate from multiple different production and/or distribution facilities. These products can be transported using any of a variety of carriers, such as trucks, railcars, and/or boats, and in many instances may involve using multiple different carriers as items are transported through the supply chain (e.g., boat for transport over ocean, rail to transport from port to distribution center, and truck from distribution center to retail store). Additionally, items may be processed through one or more distribution center before they ultimately are delivered to retail stores and/or directly to consumers. As a result, supply chains can generate large numbers of data records, such as data identifying items and carriers that are transporting the items.

Supply chain tracking and management systems have included features to simply present the data records associated with the supply chain. For example, supply chain management systems have provided users with the ability to view a current data record for an item in the supply chain as well as an ability to view a historical log of data records for the item.

### SUMMARY

The disclosed technology is generally directed to supply chain management systems and platforms to better and more accurately track and assess the state of the supply chain, including determining inventory readiness metrics which indicate whether loads and orders are on schedule for delivery to distribution centers by a target date. The supply chain management systems and platforms build off of and uses inventory ready dates (IRD) for items in the supply chain, which can be the date on which items will arrive at and be available for distribution at a distribution center (e.g., inventory unloaded from truck and available within distribution center for redistribution to, for instance, retail store or direct customer shipment). The IRD can be a singular target date that different actors and users of the supply chain can unify around, such as buyers, suppliers, distributors, carriers, and retailers. Previously, these different actors may have each had their own target dates and deadlines, which may have looked at only their smaller portion of the supply chain without broader supply chain considerations. IRD can be a unified target date against which all actors within the supply chain can organize and unify their activities around, with the ultimate goal being the holistic improvement and satisfaction of the supply chain's objectives—to supply requested items to distributors and retailers to meet demand for the items. IRD can take into account each leg of the supply chain, combining logistics, inventory management, and field operations to ensure that the IRD is accurate.

The disclosed supply chain management systems and platforms can use the IRD to track the status of the supply chain and to manage the allocation of resources, such as prioritizing shipments that have fallen behind their target IRD. The disclosed supply chain management systems and platforms can also provide visualization tools that can be used to visualize the supply chain and its contents, and to manage the supply chain.

To provide these features, which help to provide improve tracking, management, and assessment of the supply chain, including understanding changes over time to the state of the supply chain (as well as projected future states of the supply chain), the disclosed technology can use any of a variety of components, such as a load tracker which tracks the status of loads (e.g., trucks, trains) that are transporting goods to distribution centers; an order tracker which builds off of the load tracker to track the status of orders that are (often) being fulfilled across multiple loads; and user interface features that use the load tracker and the order tracker to visualize and assess the current status of the supply chain, including visualizing individual loads/orders as well as broader swaths of the supply chain. These components can track and assess supply chain features against IRDs, and these components can be combined to better determine, monitor, and assess the status of the supply chain.

In some implementations, a system can be used for the management of data. The system includes one or more processors. The system includes computer-readable memory. The computer-readable memory stores instructions that, when executed by the processors, cause the processors to perform operations include receiving order data that specifies one or more items to be purchased from one or more source locations in a supply chain for a destination location. The system also includes receiving one or more constraints for the order in the supply chain. The system also includes determining, for each item and based on the constraints, a travel path for the item to reach the destination location, the travel path defining a plurality of facilities and a plurality of travel legs that together define a travel path for the item to be shipped from a source location to a destination location. The system also includes selecting one or more milestones for the travel path based on the constraints. The system also includes selecting one or more other milestones for the travel path based on the constraints. The system also includes where one of the milestones is an inventory readiness date that specifies a first calendar date on which an order of items should be ready at each items' respective destination location. Other embodiments of this aspect include corresponding computer systems, apparatus, and computer programs recorded on one or more computer storage devices, each configured to perform the actions of the methods.

Implementations can include some, none, or all of the following features. The system where the supply chain is organized into at least two arms, and where determining, for each item and based on the constraints, a travel path for the item may include selecting one of the arms based on the constraints. One of the constraints is a date upon which a supplier will supply an item to the supply chain. One of the constraints is a date to be used as the inventory readiness date. The travel path is determined to optimize cost, given the constraints. The travel path is determined to optimize time, given the constraints. The operations further may include: determining a processing duration for each facility in the item's travel path to reflect a length of time that the facility is expected to require to process the item; determining a travel duration for each travel leg in the item's travel path to reflect a length of time that the item is expected to travel along the travel leg; generating an inventory readiness metric based on the item's travel based on tracking data for the item as the item travels from the item's respective source location to the respective destination location. The operations further may include: adjusting a particular travel duration of a particular travel leg after the particular travel duration is determined; and responsive to adjusting the particular travel duration, adjusting a particular departure date of the particular travel leg. Adjusting the particular travel duration is performed based on a record of historical performance of a shipper associated with the particular travel leg. Adjusting the particular travel duration is performed based on a travel event scheduled to occur along the particular travel leg between the particular departure date of the particular travel leg and a particular arrival date of the particular travel leg. The travel event is a weather event. The travel event is a traffic event. The operations further may include: adjusting a particular processing duration of a particular facility after the particular process duration is determined; and responsive to adjusting the particular processing duration, adjusting a particular arrival date of a preceding travel leg. Adjusting the processing duration may include is performed based on a record of historical performance of the particular facility. Adjusting the processing duration may include is performed based on a processing event scheduled to occur in the particular facility. The processing event is a work-stop event due to a holiday or a weekend. The processing event is a capital improvement in the facility that increases the productivity of the facility.

The systems, devices, program products, and processes described throughout this document can, in some instances, provide one or more of the following advantages. For example, given the magnitude of supply chain data, it can be challenging to determine the current status and state of the supply chain (e.g., on track, behind schedule, ahead of schedule). The disclosed technology provides improved solutions, over convention supply chain management systems and platforms, in that it is able to simplify this problem and provide a comprehensive solution that can permit for tracking and assessing the supply chain at a variety of different levels of granularity (e.g., load level, distribution center level, retail store department level). For instance, through the use of load tracking and order tracking, which can build on load tracking results, can be used to generate inventory readiness metrics (e.g., ahead of schedule, behind schedule, on track relative to IRD) across multiple different dimensions, including across loads (e.g., trucks, boats, trains) and across orders (e.g., purchase order placed with vendors).

In another example, the disclosed technology can improve supply chain management. For instance, complex orders made of hundreds, thousands, or millions of items can be tracked to create metrics that are far more simple than the raw tracking data, while still providing a viewer with enough information to understand the status of the order. This technology can be used for orders that will be supplied from many sources, to be sent to many destinations, by many different types of cargo haulers.

### DESCRIPTION OF DRAWINGS

FIG. 1 shows a diagram of a system for generating inventory readiness metrics.

FIG. 2 shows a flowchart of a process of generating inventory readiness metrics.

FIGS. 3 and 4 show schematic diagrams of an example readiness metric.

FIG. 5 shows a diagram of a system for generating inventory readiness metrics.

FIG. 6 shows a diagram of example data that can be used to record information related to a supply chain.

FIG. 7 shows a flowchart of an example process for generating a inventory readiness date.

FIG. 8 shows a flowchart of a process for tracking inventory readiness metrics for items in a supply chain.

FIG. 9 shows a flowchart of an example process for updating inventory readiness metrics for items in a supply chain.

FIG. 10 z is a schematic diagram that shows an example of a computing device and a mobile computing device.

Like reference symbols in the various drawings indicate like elements

### DETAILED DESCRIPTION

As described above, this document describes a technology platform for accurate tacking and assessing of the state of the supply chain, including whether loads and the orders they are on schedule for delivery to distribution centers. This technology uses an inventory ready date (IRD) as a key target for inventory shipped to destinations by the supply chain. From the IRD, various other milestone dates can be calculated. Then, orders consisting of hundreds, thousands, or millions of items are created to meet the IRD. From this, intermediate deadlines are created that, if met, make meeting the IRD likely. Metrics can be generated and displayed based on the items meeting or not meeting the deadlines created by this system.

This process can allow for IRDs to be calculated through varied sorts of logistic paths through a supply chain. For example, a single supply chain may include freight haulers in the form of truck, rail, airplane, and ship. Freight may transition through one or more facilities (e.g., loading docks, train yards, airports, ports, supply centers, stores). Each facility and hauler can require different time windows to pass freight along. In this document, techniques will be described to manage IRDs in supply chains with such complex structures.

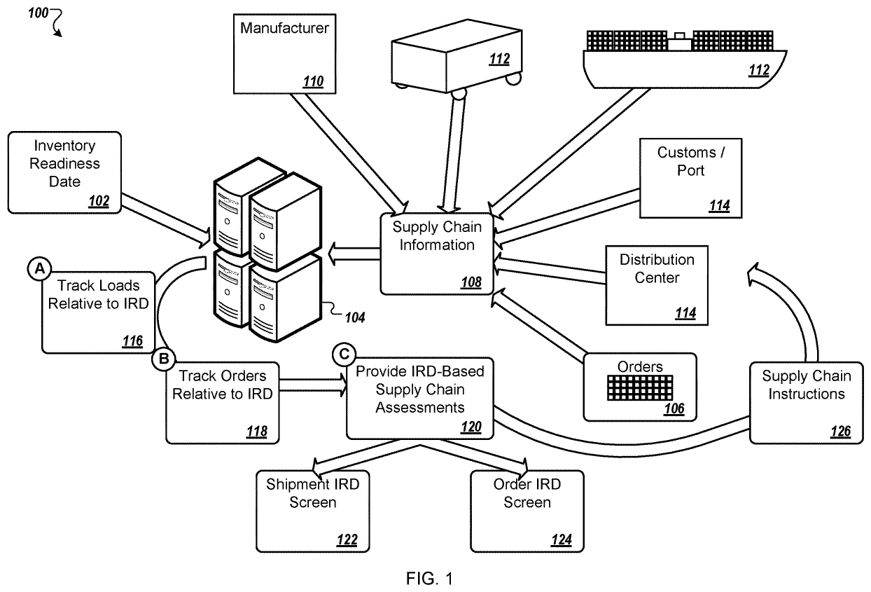

FIG. 1 shows a diagram of a system 100 for generating inventory readiness metrics. In general, an IRD 102 represents the date at which items ordered in a single order should be ready for use in a warehouse, distribution center, store, or other end location. This IRD 102 may be different, and later, than the day the items arrive at the distribution center. For example, if it takes 24 hours to unload a truck, unpack boxes, open containers, etc., before the item is sitting on the shelf ready to be accessed, the IRD 102 may be one day later than the day that the item should arrive in the truck at the distribution center.

A supply chain management computer system 104 can receive information for one or more orders 106. The orders 106 may each specify a collection of information. For example, the orders 106 may specify a list of items, a destination for each item (e.g., various stores, distribution centers), a source for each item (e.g., a factory, manufacturer, or other source of the item), price information, and/or handling information (e.g., weight, size, compatible containers). Each order 106 may be matched to an inventory readiness date 102. In this way, a large, multi-facility enterprise may be able to create complex, multi-item, multi-facility orders in a unified process.

To monitor the status of the order (e.g., to help a user understand if the manufacturers and suppliers are shipping the ordered items), the supply chain management computer system 104 can receive supply chain information 108 that contains information about the supply chain that is used to complete the orders 106. For example, the supply chain information 108 can include reporting data from manufacturers 110, including estimated and actual dates of manufacture, dates of shipment, etc. The supply chain information 108 can include reporting data for containers 112, including railcars, container trucks, ships, etc. The reporting data for containers 112 can include scheduling information, location tracking information, route information, etc. The supply chain information 108 can include reporting data from intermediate locations 114, including customs, ports, and distribution centers. In general, these intermediate locations can include locations where items, or containers holding the items, are temporarily held when in transit from their source (e.g., a manufacturer) to their destination (e.g., a fulfilment center). In some cases, the computer system 104 can filter, decorate, or otherwise alter the supply chain information 108 on receipt. For example, a large enterprise may generate a very large amount of data. Of this data, only a portion may be needed, and the unneeded portions may be filtered out. Similarly, the computer system 104 may decorate incoming supply chain information 108. For example, geolocation information may be decorated with the state or country in which the location resides.

The received information may be structured in the form of data events that each record a physical event that occurs in the supply chain. For example, a load arriving at a destination may create an event, a GPS location heartbeat message may be an event, etc. These events may be listened to by various components of the computer system 104 and, upon receipt of a new event, may launch one or more of the processes described in this document. In some cases, events may cause the update to data related to an order or load (e.g., updating location, IRD risk, or other data).

The supply chain management computer system 104 can use the received information 102, and 108 to track loads 116 relative to the IRDs 102. For example, a load in a truck may contain items for five different orders 106. The supply chain management computer system 104 may determine, for each of those five orders, if the truck's estimated arrival date will make that order's items on time, early, or late. The truck may have an estimated arrival date supplied by the trucking company, but this estimated arrival date may be different from the dates needed for IRDs 102 to be on time. For example, a delay up-stream of the shipping at the manufacturer 110 may make an IRD 102 in danger of being missed, even if the shipping by truck is done in an appropriate time. In such a way, a truck may be “on time” according to the trucking company, but the items in the truck may be “on time”, “early”, or “late” according to the IRDs 102. By separating the analysis of a carrier's performance with IRD risk, different and more useful information can be generated by the system. For example, a carrier that happens to receive loads late through no fault of their own (e.g., they service a port that has been experiencing bad weather, delaying unloading of boats) can be seen as performing well even if their loads have high IRD risk. Similarly, a carrier that often has unexpected delays but carries loads with low IRD risk may be seen as performing poorly.

The supply chain management computer system 104 can track 118 orders relative to IRDs 102. For example, with the status of each item in a load relative to IRD 102 known, the supply chain management computer system 104 can aggregate the IRD status of items in a single order across containers. This can include items from multiple sources being shipped to multiple destinations. In such a case, the breakdown of IRD status may not be a single number or value, but may instead be a multi-factor distribution of values. For example, 92% of items in an order may be on time, 5% may be early, and 3% may be late. This may be caused by most trucks carrying the items to different distribution centers carrying on-time items, two trucks carrying moving ahead of schedule, and one truck carrying items being delayed.

The supply chain management computer system 104 can provide 120 IRD-based supply chain assessments. For example, the supply chain management computer system 104 can generate one or more computer screens in the form of HTML, web pages, application interfaces, or static reports that report the status of loads relative to IRD 122, orders relative to IRD 124, or in other formats. In addition, the computer system 104 can also use the IRD-based supply chain assessments to update and improve the operations of the supply chain. For example, one or more computer-readable instructions 126 can be generated in order to implement, modify, cancel, and/or otherwise perform various supply chain operations by supply chain actors, such as manufacturers 110, carriers transporting containers 112, distribution centers and ports 114, purchase ordering systems 106, retail stores, and/or other systems and actors that are part of a supply chain. For example, the supply chain assessment 120 can be used to generate supply chain instructions 126 to send to a carrier 112 and/or intermediate location (e.g., port 114, distribution center 114) to expedite a particular load that has many items with high IRD risk. These instructions may be automatically generated and configured to cause one or more systems (e.g., automated systems, a package handling system, truck dispatch system) to perform one or more actions that can reduce the overall IRD risk of the supply chain.

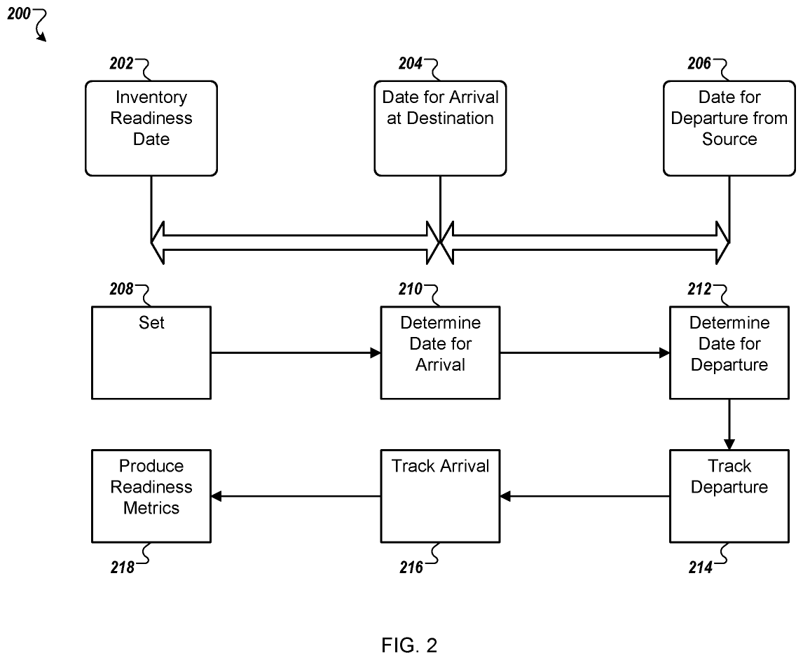

FIG. 2 shows a flowchart of a process 200 of generating inventory readiness metrics. In the process 200, an IRD 102 is set 208, and then from there intermediate dates are determined based on various factors of the supply chain. In general, these intermediate dates act as benchmarks to aid in the evaluation of IRDs 102—if the intermediate dates are being met, the order is likely on time, and if the intermediate dates are not being met, the order is likely to be late.

One intermediate date can be a date for arrival at destination 204, which may include a distribution center, a store, etc. As previously explained, the item may not be ready for use when it initially arrives at its destination. It may need to be unloaded, unpacked, inspected, assembled, and placed on a shelf, etc., before it is available for use. This process may take a significant enough amount of time that i) the process may impact the IRD if it goes slower than normal and ii) the process may be abstracted away without impacting the accuracy of the IRD analysis. For example, an item traveling down a two foot ramp from the back of a shelf to the front may take seconds and be fast enough to not need accounted for, but the unpacking discussed here may involve hours or days of work from arrival at the destination.

One intermediate date can be a date of departure from the item's source 206. This source may in some cases be the location where the item is manufactured, mined, generated, or assembled. In some cases, the source may be the first point at which the supply chain is automatically monitored. For example, a supplier of raw materials may not provide detailed, electronic tracking information until the raw materials arrive at the customs-controlled port where the material is being exported. In such a case, the customs-controlled port may be the source of the item, even if it is hundreds of miles from where the raw material is grown, extracted, manufactured, etc.

Two intermediate dates are shown here, but other intermediate dates can be used, including more or fewer dates. For example, if the items must from the source by rail car, then by ship, then by truck before arrival at the destination, additional intermediate dates may be used to represent the transition from rail to ship, and from ship to truck, as well as additional intermediate dates within each of those modes of transit (e.g., intermediate date for carrier reaching one or more intermediate locations and/or progress points). Additional and/or alternative intermediate dates can include stops in which some, but not all, of a load are unloaded or loaded. For example, a truck may have a load with items destined for two different retail stores, and each arrival and departure from the two retail stores may also have an intermediate date.

An IRD is set 208. For example, a computer system can receive, from outside of the computer system, input that specifies and IRD. This input may take the form of user input entering the data through a graphical user interface (GUI). This input may take the form of a data message transmitted over a data network. The receiving computer system can, using the input, store the IRD to computer memory to specify a first calendar date on which an order of items should be ready at each items' respective destination location. In some cases, the IRD is received as part of input that specifies the order for the computer system.

An arrival date is determined for each item of the order 210. For example, the computer system may access data for each item of the order and identify a destination for that item. For example, the order may specify one million identical items, with ten thousand items being ordered for each of one hundred distribution centers located across a country. Each distribution may have recorded the number of days that the center normally takes to unload and make ready such items—one day, two days, or three days. As such, the computer system may determine arrival dates 204 for each distribution center that are one day, two days, or three days before the IRD 202. As such, for each item of the order, an arrival date is set before the readiness date, the arrival date specifying a second calendar date on which the item should arrive at the item's respective destination location.

A departure date is determined for each item of the order 212. For example, the computer system may access data for each item of the order and identify a source for that item. For example, the items may be shipped from one of three factories spread across the country. Given the source of the item along with the destination now, the computer system can determine a length of time needed to transport the item from the source to the destination. Working backwards from the arrival date 204, the computer system can determine a departure date before the arrival date, the departure date specifying a third calendar date on which the item should depart the item's respective source location. For example, if a particular item has an IRD 202 of Friday, an arrival date 204 of Thursday, and requires two days to transit from the source to the destination, a departure date of Tuesday may be determined.

In some cases, determining, for each item of the order, an arrival date and determining, for each item of the order, a departure date, comprises querying a user for the second calendar date and the third calendar date. For example, the computer system may generate one or more GUIs to provide a user with an order specification screen. The user may input, into the screen, details about the order. This can include the IRD, the arrival date 204, and the departure date. In some implementations, this information may be generated based on secondary considerations input by the user. For example, the user may specify an IRD 202 and request arrival dates and departure dates calculated to reduce transit costs, time in transit, storage overhead, etc. In another example, the user may enter the departure date, as that may be inflexibly set by the manufacturer, and from there the GUI may guide the user to select other aspects of the order (e.g., shipping method or IRD), and the system may proposed values given those inputs (e.g., providing an IRD given the shipping method, providing a recommended shipping method given the IRD).

Events such as departure events are tracked 214 and arrival events are tracked 216. For example, as the items move through the supply chain, the computer system may receive tracking updates of such movement and identify transit events (e.g., departure events, arrival events). Based on these events, the computer system can keep up-to-date of location data for each item. In addition, estimates of future arrivals and/or departures can be updated based on the new information, and these projections can be compared against IRD to determine the risk level for various items (e.g., high risk of item missing IRD based on projected arrival date). For example, if a load arrives to one destination a day early, projected future arrivals and departures may be adjusted by one day to reflect this updated understanding of load status, which can additionally update the IRD-based status of the items contained with the load.

In some cases, this process can include receiving tracking data from a plurality of shipping containers, each shipping container containing at least one of the items. These shipping containers can include vehicles such as trucks, rail cars, and ships that may have global positioning data (GPS) or route data reported. These shipping containers can include boxes, bins, bags, or pallets that include bar codes, wireless data tags, or other technology used to generate tracking information. As the various types of shipping have different real-world capabilities and options (e.g., trucks can unload at a store, but boats are unlikely to) data for each type of container can be configured to reflect those real world capabilities and options. As such, data for different containers may be handled differently by the systems.

Readiness metrics are produced 218. For example, for each item of the order discussed in this example, the computer system can generate an inventory readiness metric based on the item's travel based on tracking data for the item as the item travels from the item's respective source location to the respective destination location. For example, the computer system can compare actual departure events and actual arrival events to the planned arrival date 204 and the planned departure date 206.

In one example, items that actually depart or arrive before their planned dates can be tagged as “ahead of schedule”, items that actually depart or arrive on their planned dates can be tagged as “on schedule”, and items that actually depart or arrive after their planned dates can be tagged as “behind schedule.” In another example, the metric can report a risk of being behind schedule. Items with actual dates ahead of or on the planned dates can be tagged as low risk, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

As tracking events are received, the computer system can continually update the IRD metrics. For example, a particular item may have an actual departure date matching the planned departure date 206. The rail car carrying the item may be delayed in transit, taking four days to travel instead of the planned two, resulting in an actual arrival date that is two days after the planned arrival date 204. In such a case, the item may initially be given an “on time”, “green” or otherwise favorable IRD metric. However, when the arrival date lapses (or when another intermediate date lapses), the computer system can update the readiness metric for that item to “late”, “red”, or otherwise unfavorable.

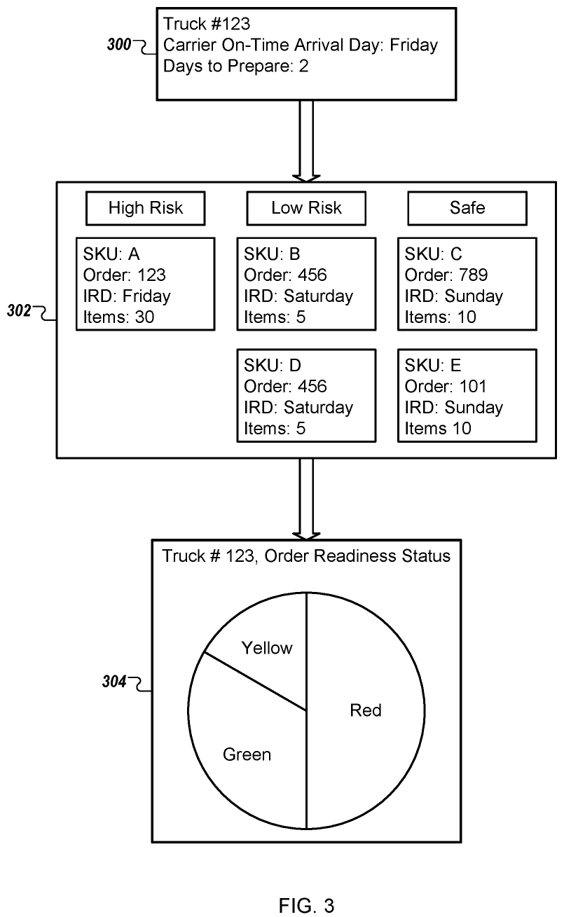

FIG. 3 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 300 can be stored by a computer system to record data related to a container that is used to ship items for an order. For example, items for the order may be recorded as in transit on truck #123. The carrier may have a carrier-scheduled on-time arrival date of Friday. However, as explained above, this date may be different from the IRD or other intermediate dates used to determine IRD metrics. In addition, the data 300 can record the number of days needed to unpack and make ready the items once they reach their destination.

Data 302 can be stored by the computer system to maintain the IRD status of items in the truck #123. In this example, the truck is carrying a total of 60 items across five Stock Keeping Units (SKUs). These 60 items are each assigned to one of four orders, but have been shipped in the truck #123 to enhance overall efficiency of the supply chain. Because they are part of different orders, they may have assigned different IRDs. As such, items from the same truck—a truck that the carrier identifies as “on time”—can nevertheless have different IRD metrics. In this case, items with an IRD of Friday are more than a day behind schedule and marked as “high risk”, items a day behind schedule are marked as “at risk”, while items on schedule are marked as “safe”.

Report 304 reports the risk status of the items in the truck in the form of a multi-factor metric that represents the inventory readiness metric of each item contained by the container. Of note, the pie chart of the report 304 reports risk weighted by item count, not by SKU. So while there are five SKUs in the truck, one SKU contains half of the items and those items are at risk. As such, the pie chart shows half of the area marked “red” for “high risk”. Similarly, “low risk” and “safe” have the same number of SKUs but different numbers of items, and thus the “yellow” and “green” areas are of unequal size.

The report 304 may be displayed to a user on a screen, by being printed on paper, etc. With this information, the user can quickly identify the status of the items in the truck and determine if any remedial action should be taken. For example, as this report contains large amounts of red followed by yellow, the user may identify it as a high-priority for redial action. As such, the user may generate an order for the supply chain to expedite the truck #123.

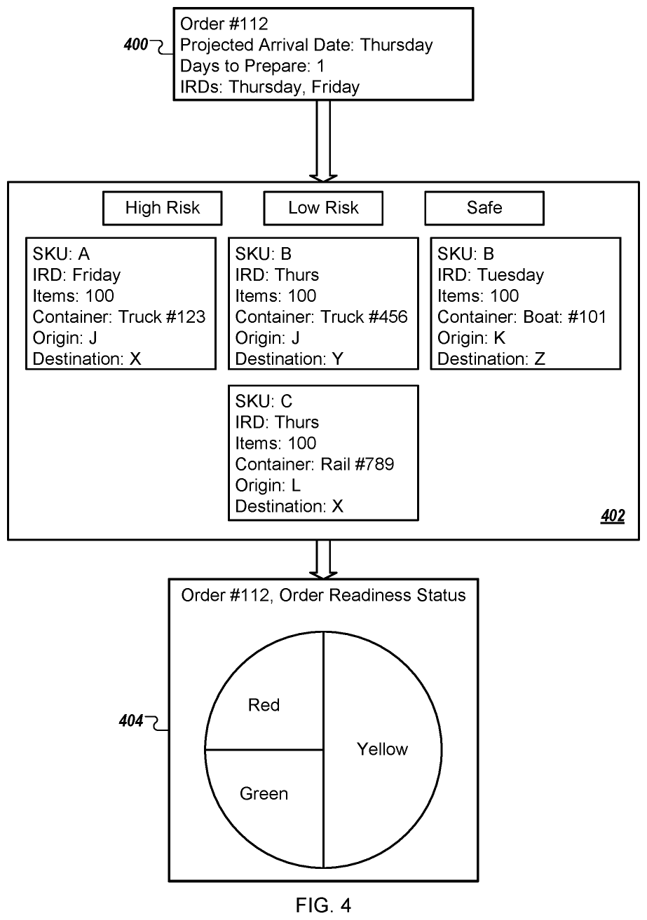

FIG. 4 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 400 can be stored by a computer system to record data related to items for an order across many containers. For example, items for the order #112 may be recorded with associated metadata. For example, the data 400 can record the IRD for an order and number of days needed to unpack and make ready the items once they reach their destination.

Data 402 can be stored by the computer system to maintain a projected arrival date of items in the order #112. In this example, 400 items are being transported from various sources, to various destinations, as grouped together by three different SKUs of items (A, B, and C) being transported from three different origin locations (J, K, and L) to three different destinations (X, Y, and Z across four different containers, truck #123, truck #456, rail car #789, and boat #101. As depicted by the combinations of SKU, source location, destination location, and containers that are part of order #112, an order can include multiple different items (e.g., SKUs A, B, and C) that are fulfilled from multiple different source locations (e.g., origins J, K, and L) to multiple different destination locations (e.g., destinations X, Y, and Z) using multiple different carriers (e.g., truck #123, truck #456, rail car #789, and boat #101). In addition, orders with different SKUs can have different IDRs to the same location. For example, SKU A may have an IRD of Thursday and SKU B may have an IRD on a different day (e.g., Friday). Due to this complexity, simply tracking the progress of each of portion of an order is a challenge, let alone the added difficulty in assessing the overall and current IRD-based risk of the order (and its component parts) being unavailable across all of these different moving parts (e.g., different SKUs, source locations, destinations, containers). For example, because each items that is part of the order (represented by SKUs) may be at different points in its transit path, they may have assigned different statuses. As items transition along their transit path, which may include being transferred between different containers, the status of the items and their projection relative to IRD can be updated (e.g., events identifying progress of items can be received and used to update IRD-based status for items). As such, items set to arrive at least a day before the IRD are set to “safe”, items set to arrive on the IRD date are marked “low risk”, and items arriving after the IRD date are marked as “high risk”. Other rating schemes may be used.

Report 404 reports the risk status of items in the order in the form of a first multi-factor metric that represents the inventory readiness metric of each item of the order. Of note, the pie chart of the report 404 reports risk weighted by item count, not by container. However, in this case, each container contains the same number of items, so the size of each section of the chart happens to correlate to the number of containers in each risk category.

The report 404 may be displayed to a user on a screen, by being printed on paper, etc. With this information, the user can quickly identify the status of the items in the order and determine if any remedial action should be taken. For example, as this report contains large amounts of red followed by yellow, the user may identify it as a high-priority for redial action. As such, the user may generate an order for the supply chain to temporarily halt activities that use many of the items in the order #112.

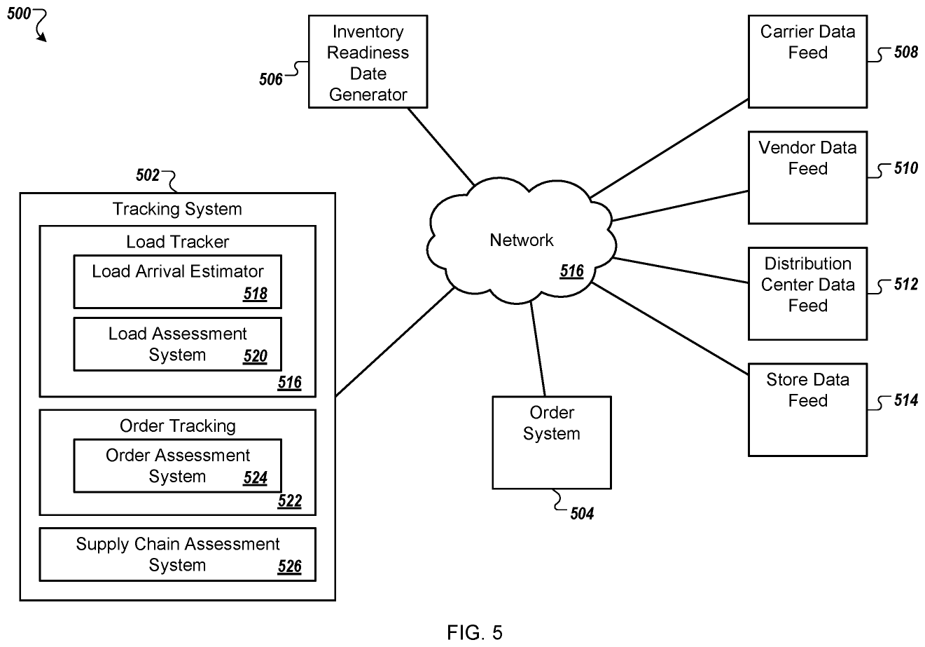

FIG. 5 shows a diagram of a system 500 that includes computer devices that operate to generate inventory readiness metrics. In the system 500, a tracking system 502 can receive data from other elements of the system 500 and can generate new data to report on the status of the supply chain. For example, an order system 504 can report, to the tracking system 502, details about orders that are to be fulfilled using the supply chain. This order information can include a listing of items in the order, sources for the items, destinations for the items, etc. An inventory readiness date generator 506 can generate, from the order information and other data in the system 500, inventory readiness dates for the orders.

Various data feeds can supply data to the tracking system 502 on an ongoing basis. A carrier data feed 508 can supply the tracking system 502 with carrier tracking data. This data can include shipping events (e.g., departure from a particular location by a particular container), status data (e.g., geolocation data, speed, direction, fuel status), and carrier-based-status values (e.g., on time, ahead of schedule, or late, according to carrier quality of service agreements).

A vendor data feed 510 can supply the tracking system 502 with vendor tracking data. This data can include vendor events (e.g., sale of items that are ordered), status data (e.g., where items are in the manufacturing process), and vendor-based-status values (e.g., if the manufacturing process is on time, ahead of schedule, or late, according to vendor contracts). A distribution center data feed 512 can supply the tracking system 502 with distribution center tracking data. This data can include information about the status of items in the distribution center (e.g., including both items that were ordered as part of the orders discussed above and items not ordered as discussed), and the capabilities of the distribution center (e.g., time to unload items, ability to sort and assemble parts). A store data feed 514 can supply the tracking system 502 with store tracking data. This data can include information about the status of items arriving and for sale at stores, and the capabilities of the stores (e.g., time to unload items, ability to sort and assemble parts).

A network 516 can provide data communication between elements of the system 500. For example, the data network can create, maintain, and tear down data connections that allow messages to be sent by one element and received by another element. The network 516 can include the Internet, private networks, public networks, etc.

The tracking system 502 can include a load tracker 516 that is able to execute operations to track loads of items. For example, the load tracker 516 may maintain, in computer memory, a list of loads in containers. This list of containers can also include, for each container, a list of items in the load, the order number of the items, the locations of the containers, etc. A load arrival estimator 518 can execute operations to estimate arrival times of loads. For example, the load estimator 518 may maintain, in computer memory, a list of planned arrival dates (e.g., arrival dates 204) for each load being tracked. The load estimator 518 may also store other data to determine if the loads being tracked are likely to meet their planned arrival dates. For example, this data may include intermediate benchmarks, geolocation data, travel velocity, traffic data, weather data, etc. This other data may be submitted to a classifier to identify one or more likely arrival dates.

A load assessment system 520 may submit this other data (e.g., the intermediate benchmarks, geolocation data, travel velocity, traffic data, weather data, etc.) to one or more classifier functions that return one or more estimated arrival dates, given the input. This estimated date may take the form of a single date estimated to be the most likely, a plurality of dates each having an associated confidence value, etc.

The tracking system 502 can include an order tracking system 522 that is able to execute operations to track orders of items. For example, the order tracker may maintain, in computer memory, a list of orders of items. This list of orders can also include, for each order, a list of containers containing items of the order, SKUs of the items, etc. A order assessment system 524 may submit data received from the load tracker 516 (e.g., estimated arrival times) to one or more classifier functions that return one or more order risk scores that report the risk each item of the order has of missing its assigned IRD.

A supply chain assessment system 526 of the tracking system 502 can generate assessments of the supply chain. For example, the system 526 can generate the screens 112 and 124, the report 304, and or the report 404.

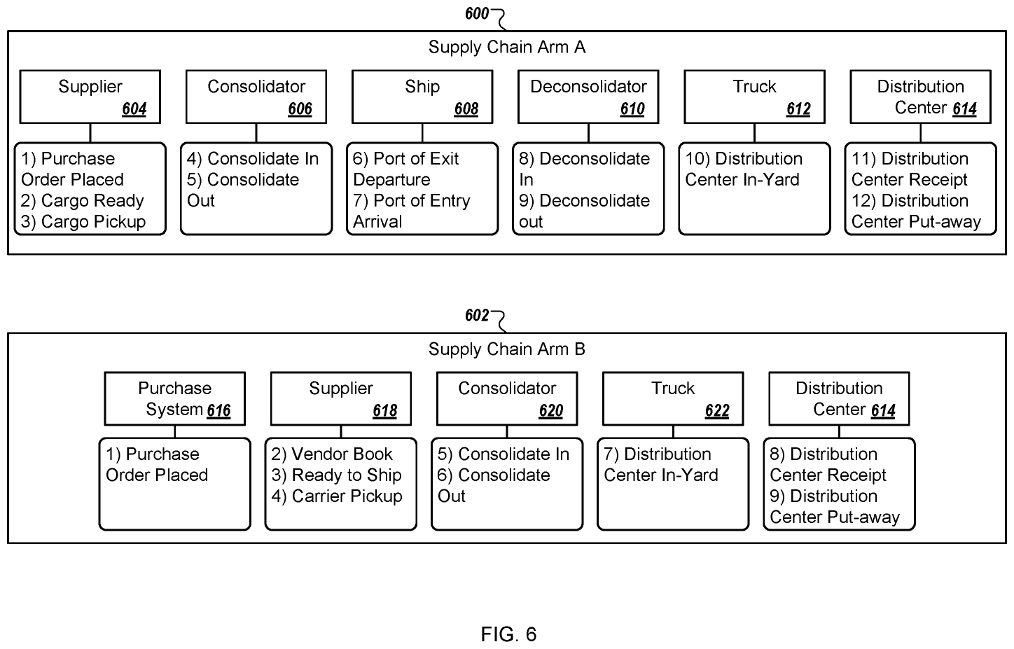

FIG. 6 shows a diagram of example data 600 and 602 that can be used to record information related to a supply chain. For example, the data 600 and 602 may be stored in the tracking system 502 or in another memory location accessible to elements of the system 500. This information, along with IRDs, can be used to determine intermediate milestones, as is described elsewhere in this document. For example, in order for IRDs to be met, a series of earlier dates called milestones can be generated. Locations in an arm of a supply chain can have one or more milestones associated (e.g., arrival at and departure from). With these milestones, actors in the supply chain can operate to hit their local milestones (e.g., the departure date of that facility) instead of the IRD at the end of the chain. This can advantageously allow for better management and control of operations within the supply chain. Additionally, problems that develop can be understood and reacted to before and IRD is missed. If a milestone is missed, for example, extra resources may be allocated to catch a shipment up to the schedule even before the IRD is missed and/or shipments can be rerouted, reprioritized, etc.

A supply chain can include one or more arms. Generally speaking, each arm of the supply chain can service destinations (e.g., distribution centers, stores) in different ways and/or from different types of sources (e.g., suppliers, manufacturers, growers). For example, a network of distribution centers may have one supply chain arm for domestically-sourced items and a second supply chain arm for internationally-sourced goods. The international arm may include intermediate points for customs, duties, etc. that are not needed for the domestic arm. In another example, a chain of grocery stores with locations on the east coast and west coast of a nation may have an east-coast arm to move food-items from east-coast growers to east-coast stores and a west-coast arm to move food from west-coast growers to west-coast stores. As will be understood, the arms may overlap in terms of geography, may share some intermediate destinations, etc.

Data 600 records a path through supply chain arm A. In this example, the supply chain arm A is for internationally-sourced goods. The path includes a supplier 604 such as a manufacturer of goods. A consolidator 606 can receive the goods (e.g., stored on pallets) and consolidate the goods into shipping containers, possibly with goods for other orders, from other suppliers, etc. A ship 608 (e.g., a container ship) can be loaded with containers from the consolidator 606 and transport the containers over sea, through customs, etc., to a deconsolidator 610. The deconsolidator 610 can unload the containers and load the pallets onto trucks, or can place the containers onto trucks 612 without opening the containers. The truck 612 can transport the goods over roadways to a distribution center 614.

Data 602 records a path through supply chain arm B. In this example, the supply chain arm B is for domestically-sourced goods. The path includes a purchase system 616. The purchase system 616 can include computer devices that receive data from the system 500, including purchase orders. For example, the purchase system 616 can provide a web-page for a user to enter details of a purchase order. A supplier 618 such as a manufacturer of goods. A consolidator 620 can receive the goods (e.g., stored on pallets) and consolidate the goods into shipping containers or onto transport, possibly with goods for other orders, from other suppliers, etc. A truck 622 can transport the goods over roadways to the distribution center 614, which, in this example, is the same distribution center that receives goods in the path stored in the data 600 as well, though it need not be in other examples.

The data 600 and 602 can also include one or more milestones for each location in the path. As shown here, the supplier 604 can a milestone for a purchase order placed, for cargo-ready, for cargo-pickup, etc. While a particular type, order, and number of milestones are shown here, a different types, orders, and numbers of milestones may be used.

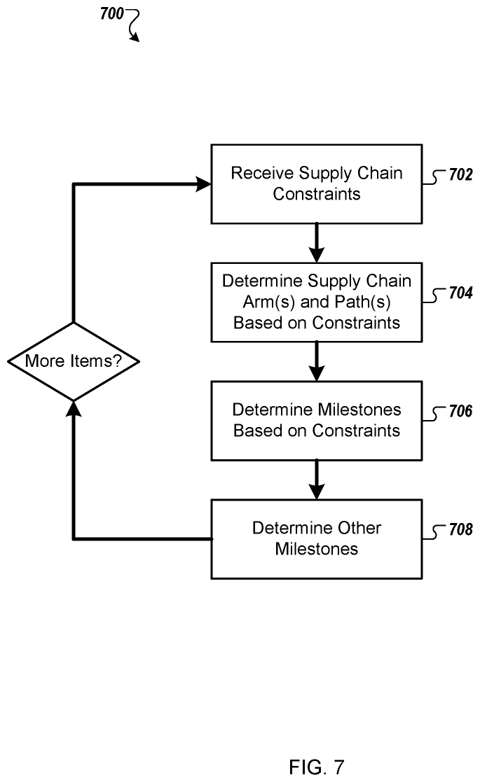

FIG. 7 shows a flowchart of an example process 700 for generating an inventory readiness date. In the process 700, and IRD and other milestones for an order may be determined from one or more constraints. For example, the process 700 can be performed by the IR-D generator 506.

Supply chain constraints are received 704. For example, an order may have one or more constraints imposed by business, logistic, manufacturing, or other reasons. In some cases, one of the constraints is a date upon which a supplier will supply an item to the supply chain. That is to say, an order placed may be assigned a particular date on which it will be fulfilled by the supplier. This may be used, for example, when dealing with regular, high-turnover items that are ordered on a repeated basis.

In some cases, one of the constraints is a date to be used as the inventory readiness date. That is to say, an order may be placed in order to meet a specific, time-related goal for the items in the order. One such example is the stocking of store shelves for a holiday or a sale. A popular sporting event may be scheduled, and an order to “tailgate food’ like carbonated beverages, chicken wings, and hot dogs may be placed so that they are available two days before the game. In such a case, that date two days before the game may be used as an IRD to be a constraint on the order. Further, the store or stores to be stocked can also be identified as a constraint. As will be appreciated, this may include a large number of stores for a national or international retail chain, for example. And in this way, a series of constraints specifying various combinations of products, stores, and dates may be accounted for, including very large, complex combinations.

Supply chain arms and/or paths are determined based on the constraints 706. For example, the IRD generator 506 can access data that defines each available facility in the supply chain and each possible mode of transport between each facility. With this data, the IRD generator 506 can select a travel path defining a plurality of facilities and a plurality of travel legs that together define a travel path for the item to be shipped from a source location to a destination location. This selection may be based in order to optimize one goal or a mix of goals. For example, given the constraints of a given IRD and a given date of availability, the IRD generator 506 can identify candidate paths that move items from the source, on the date of availability, to the destination in time for the IRD to be met. From these candidate paths, one path may be selected. This determination of the selected path may be based on time, in order to, for example, provide the most robustness in the face of unexpected delays. This determination may be based on cost, to find the lowest cost option out of the possible valid options. This determination may be based on a weighted mix of cost, time, and/or other parameters.

With these determined, various plans to move the items through the supply chain arms are determined. For example, freight haulers can be booked, automated machine can be instructed, and human resources can be requested. This can specify the types of transportation to be used, how the items will be provided to transporter, etc.

Milestones are selected based on the constraints. For example, with the path selected and the constraints available, milestones to match the constraints may be recorded. In the case of the given IRD and given date available, a “cargo ready” milestone for the supplier may be set as the date available, and “on shelf” milestone for a store may be set as the IRD.

Other milestones are determined 710. For example, other milestones in the travel path may be set based on the constraint-set milestones. If, for example, the items take two days to travel from the supplier to a consolidator, a “consolidate in” date two days after the “cargo ready” can be set. Similarly if it takes three days to unpack the goods at the store, a “store receipt” milestone may be set three days before the IRD.

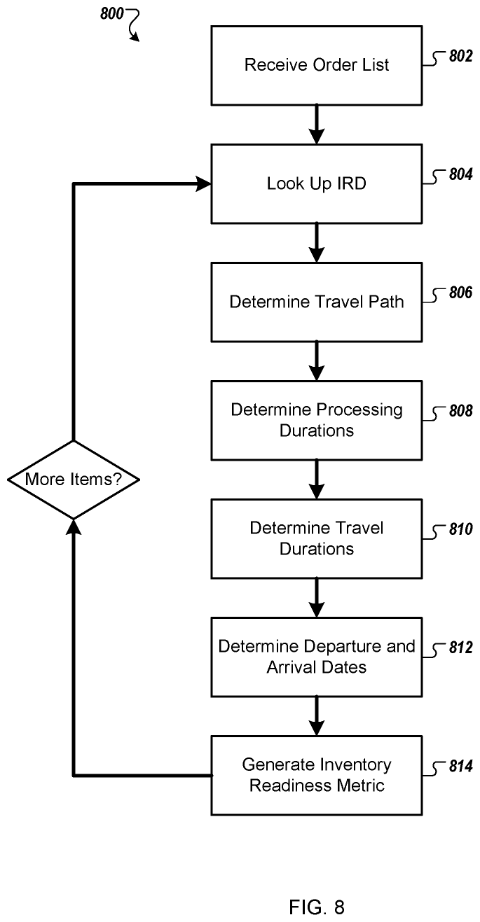

FIG. 8 shows a flowchart of a process 800 for tracking inventory readiness metrics for items in a supply chain. For example, the process 800 can be performed by the tracking system 502. Therefore, the process 800 will be described with reference to the system 500. The process 800 may be performed, for example, after a new order has been received and IRDs have been set for the items contained within the order.

An order list is received 802. For example, the load tracking system 502 can receive, from the order system 504, a file listing all items specified by a single order. Additionally or alternatively, the order tracking system 522 can receive, from other data sources, a list of all loads that specify items in the load. From this complete list of loads, order may be assembled by combining items with similar order characteristics. The order tracking system 522 can store this order tracking information in computer memory.

An IRD status for each item is initially determined up 804. The order assessment system 524 can listen for updates in the computer memory. When a new order list is created in 802, the order assessment system 524 can access IRD dates for each item from the IRD generator 506. As will be appreciated, the order may specify many different IRDs, each associated with various locations (stores, distribution centers, pickup locations, clinics).

A travel path for each item in the order is determined 806. The travel path can be configured to define a plurality of facilities and a plurality of travel legs that together define a travel path for the item to be shipped from a source location to a destination location. For example, the supply chain assessment system 526 may record or access a list of all possible carriers, vendors, distribution centers, stores, etc. that are available to move the times in the order from their source location to their destination location. The supply chain assessment system 526 can then solve for the best path in the supply chain from the source location to the destination location, based on a function to find the best path that considers price, time, complexity, risk of loss, etc. This path may being at the source location as the initial facility, specify a travel leg to an intermediate location as another facility, another travel leg to another facility, etc., until the path terminates at the destination location. While FIG. 200 describes a path with only a source locations, a destination location, and a single travel leg, interstitial facilities such as docks, rail yards, etc. may be used in more complex paths. In such paths, the supply chain assessment system 526 can record an ordered list of the facilities and travel legs to record the determined travel path.

Processing durations for each item in the order are determined 808. For example, processing duration for each facility in the item's travel path can be determined by the supply chain assessment system 526 in order to reflect a length of time that the facility is expected to require to process the item. That is to say, if a particular dock regularly requires 6 hours to unload containers to trucks, with a worst-case time of 12 hours, the supply chain assessment system 526 may determine a time of 6 hours, 12 hours, or a value in between to weigh accuracy vs worst-case planning.

Travel durations for each item in the order are determined 810. For example, travel durations for each travel leg in the item's travel path can be determined by the supply chain assessment system 526 to reflect a length of time that the item is expected to travel along the travel leg. For example, the length of road traveled in a travel leg and the speed limit, or common traffic speed for trucks, may be used to determine the length of time needed for a truck to travel along the travel leg.

Departure and arrival dates for each item in the order are generated 812. For example, the supply chain assessment system 526 can determine, for each travel leg, a departure date and an arrival date based on the inventory readiness date, processing durations, and travel durations that allow the item to reach its destination location in time to meet the IRD. For example, the supply chain assessment system 526 may work backward from the IRD to specify an arrival date of the immediately previous travel leg based on the processing duration of the destination location, then determine the departure time for that travel leg based on the travel time, etc., until all departure and arrival times are set. In some configurations, these departure and arrival dates may be tied to the facilities in addition to, or instead of, the travel legs.

An inventory readiness metric for each item is generated 814. For example, based on the item's travel based on tracking data for the item as the item travels from the item's respective source location to the respective destination location, the supply chain, the supply chain assessment system 526 can determine a risk of missing the IRD. If the item is ahead of schedule, the risk may be tagged as low and if the item is behind schedule, the risk may be tagged as high.

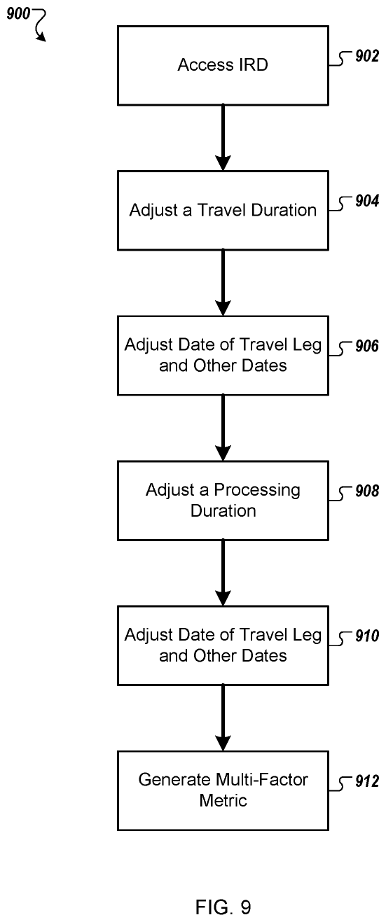

FIG. 9 shows a flowchart of an example process 900 for updating inventory readiness metrics for items in a supply chain and lead time governance. For example, the process 900 can be performed by the tracking system 502 after performing the process 800. Therefore, the process 900 will be described with reference to the system 500.

An IRD for an item is accessed 902. For example, the supply chain assessment system 526 can access the IRD generated by the order assessment system 524 for the particular item at issue.

A travel duration for the item is adjusted 904. For example, the supply chain assessment system 526 may identify one or more events in the supply chain that may change the time it takes for an item to travel along a particular travel leg. This change may be an increase in time, or this change may be a decrease in time, depending on the type of event.

One type of event may be a determination that that a particular shipper has a history of increased or decreased travel durations. Based on a record of historical performance of a shipper associated with the particular travel leg, the supply chain assessment system 526 may increase or decrease the travel duration for the travel leg. That is to say, a historically fast shipper may cause the supply chain assessment system 526 to reduce the travel delay of a particular travel leg along which this speedy shipper will be shipping an item.

One type of event may be a determination that a weather event is predicted to occur along the travel leg while the item is being transited along that travel leg. As will be understood, snow, rain, etc. may cause shipping delays for boats, trucks, etc. In such situation, the supply chain assessment system 526 may increase the travel time based on an estimated impact of the weather event.

One type of event may be a determination that a traffic event is predicted to occur along the travel leg while the item is being transited along that travel leg. For example, travel through a metro-area's rush hour my greatly increase the travel delay, compared to travel through the same metro-area in the early morning, on the weekend, etc.

A date of a travel leg and other dates are adjusted 906. With one date adjusted, the supply chain assessment system 526 may propagate a similar change through previous or subsequent arrival dates and departure dates in the travel path. For example, if a travel duration is increased by three hours, all previous dates may be adjusted by three hours to compensate. For a travel duration that is decreased by three hours, all subsequent dates may be adjusted by three hours to compensate. Or vise versa.

A processing duration for the item is adjusted 908. For example, the supply chain assessment system 526 may identify one or more events in the supply chain that may change the time it takes for a facility to process a particular item. This change may be an increase in time, or this change may be a decrease in time, depending on the type of event.

One type of event may be a determination that a particular facility has a history of increased or decreased processing times. Based on a record of historical performance of the particular facility, the supply chain assessment system 526 may increase or decrease the processing duration for the facility in the travel path. That is to say, a historically fast facility may cause the supply chain assessment system 526 to reduce the processing delay of a particular processing duration for the facility, resulting in a departure date for the next travel leg being adjusted.

One type of event may be a work-stop event due to a holiday or a weekend. For example, the supply chain assessment system 526 may determine that an arrival date for a travel leg may result in a delivery to a facility that is not open or not processing deliveries due to the facility being closed that day. In such a case, the supply chain assessment system 526 can increase the processing duration of the facility to reflect this down-time.

One type of event may be a capital improvement in the facility. For example, installation of new package handling equipment, a new loading dock, etc., may result in a facility able to process items in less time. In such a case, the supply chain assessment system 526 can reduce the processing duration of the facility to reflect this increased efficiency.

A date of a travel leg and other dates are adjusted 910. With one date adjusted, the supply chain assessment system 526 may propagate a similar change through previous or subsequent arrival dates and departure dates in the travel path. For example, if a processing duration is increased by three hours, all previous dates may be adjusted by three hours to compensate. For a travel duration that is decreased by three hours, all subsequent dates may be adjusted by three hours to compensate. Or vise versa.

An inventory readiness metric for the item is generated 912. For example, based on the item's travel based on tracking data for the item as the item travels from the item's respective source location to the respective destination location, the supply chain, the assessment system 526 can determine a risk of missing the IRD. If the item is ahead of schedule, the risk may be tagged as low and if the item is behind schedule, the risk may be tagged as high.

As can be seen, a change to arrival and departure dates may impact the inventory readiness metric for an item already in transit. By increasing a delay, and thus pushing the arrival and departure dates, a low-risk, in transit item may become a high risk item.

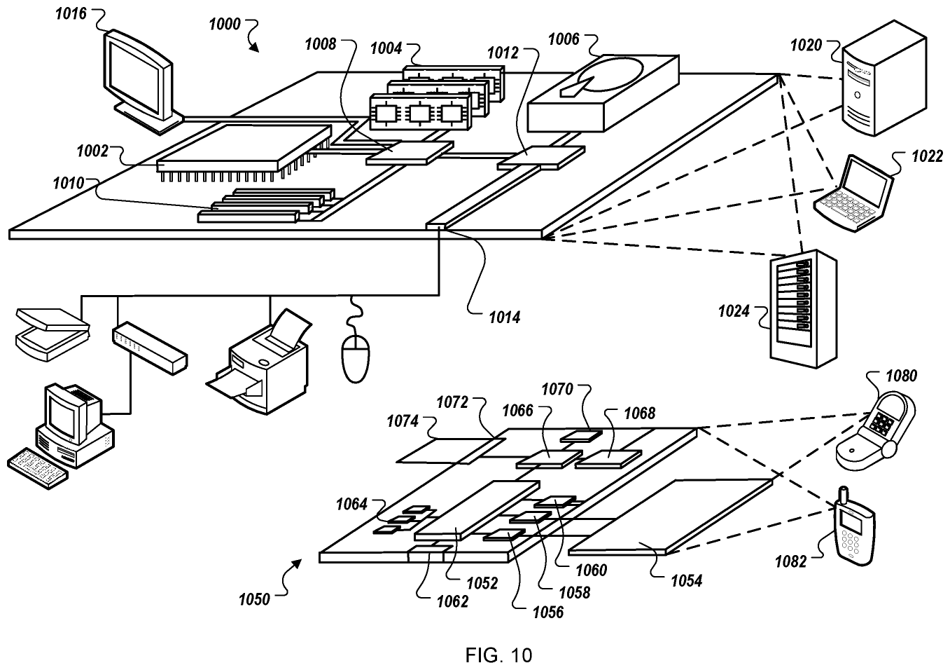

FIG. 10 shows an example of a computing device 1000 and an example of a mobile computing device that can be used to implement the techniques described here. The computing device 1000 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 1006, the high-speed interface 1008, the high-speed expansion ports 1010, and the low-speed interface 1012, are interconnected using various busses, and can be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1004 stores information within the computing device 1000. In some implementations, the memory 1004 is a volatile memory unit or units. In some implementations, the memory 1004 is a non-volatile memory unit or units. The memory 1004 can also be another form of computer-readable medium, such as a magnetic or optical disk.

The storage device 1006 is capable of providing mass storage for the computing device 1000. In some implementations, the storage device 1006 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1004, the storage device 1006, or memory on the processor 1002.

The high-speed interface 1008 manages bandwidth-intensive operations for the computing device 1000, while the low-speed interface 1012 manages lower bandwidth-intensive operations. Such allocation of functions is exemplary only. In some implementations, the high-speed interface 1008 is coupled to the memory 1004, the display 1016 (e.g., through a graphics processor or accelerator), and to the high-speed expansion ports 1010, which can accept various expansion cards (not shown). In the implementation, the low-speed interface 1012 is coupled to the storage device 1006 and the low-speed expansion port 1014. The low-speed expansion port 1014, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1000 can be implemented in a number of different forms, as shown in the figure. For example, it can be implemented as a standard server 1020, or multiple times in a group of such servers. In addition, it can be implemented in a personal computer such as a laptop computer 1022. It can also be implemented as part of a rack server system 1024. Alternatively, components from the computing device 1000 can be combined with other components in a mobile device (not shown), such as a mobile computing device 1050. Each of such devices can contain one or more of the computing device 1000 and the mobile computing device 1050, and an entire system can be made up of multiple computing devices communicating with each other.

The mobile computing device 1050 includes a processor 1052, a memory 1064, an input/output device such as a display 1054, a communication interface 1066, and a transceiver 1068, among other components. The mobile computing device 1050 can also be provided with a storage device, such as a micro-drive or other device, to provide additional storage. Each of the processor 1052, the memory 1064, the display 1054, the communication interface 1066, and the transceiver 1068, are interconnected using various buses, and several of the components can be mounted on a common motherboard or in other manners as appropriate.

The processor 1052 can execute instructions within the mobile computing device 1050, including instructions stored in the memory 1064. The processor 1052 can be implemented as a chipset of chips that include separate and multiple analog and digital processors. The processor 1052 can provide, for example, for coordination of the other components of the mobile computing device 1050, such as control of user interfaces, applications run by the mobile computing device 1050, and wireless communication by the mobile computing device 1050.

The processor 1052 can communicate with a user through a control interface 1058 and a display interface 1056 coupled to the display 1054. The display 1054 can be, for example, a TFT (Thin-Film-Transistor Liquid Crystal Display) display or an OLED (Organic Light Emitting Diode) display, or other appropriate display technology. The display interface 1056 can comprise appropriate circuitry for driving the display 1054 to present graphical and other information to a user. The control interface 1058 can receive commands from a user and convert them for submission to the processor 1052. In addition, an external interface 1062 can provide communication with the processor 1052, so as to enable near area communication of the mobile computing device 1050 with other devices. The external interface 1062 can provide, for example, for wired communication in some implementations, or for wireless communication in other implementations, and multiple interfaces can also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 can also be provided and connected to the mobile computing device 1050 through an expansion interface 1072, which can include, for example, a SIMM (Single In Line Memory Module) card interface. The expansion memory 1074 can provide extra storage space for the mobile computing device 1050, or can also store applications or other information for the mobile computing device 1050. Specifically, the expansion memory 1074 can include instructions to carry out or supplement the processes described above, and can include secure information also. Thus, for example, the expansion memory 1074 can be provide as a security module for the mobile computing device 1050, and can be programmed with instructions that permit secure use of the mobile computing device 1050. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1064, the expansion memory 1074, or memory on the processor 1052. In some implementations, the computer program product can be received in a propagated signal, for example, over the transceiver 1068 or the external interface 1062.

The mobile computing device 1050 can communicate wirelessly through the communication interface 1066, which can include digital signal processing circuitry where necessary. The communication interface 1066 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1068 using a radio-frequency. In addition, short-range communication can occur, such as using a Bluetooth, WiFi, or other such transceiver (not shown). In addition, a GPS (Global Positioning System) receiver module 1070 can provide additional navigation- and location-related wireless data to the mobile computing device 1050, which can be used as appropriate by applications running on the mobile computing device 1050.

The mobile computing device 1050 can also communicate audibly using an audio codec 1060, which can receive spoken information from a user and convert it to usable digital information. The audio codec 1060 can likewise generate audible sound for a user, such as through a speaker, e.g., in a handset of the mobile computing device 1050. Such sound can include sound from voice telephone calls, can include recorded sound (e.g., voice messages, music files, etc.) and can also include sound generated by applications operating on the mobile computing device 1050.

The mobile computing device 1050 can be implemented in a number of different forms, as shown in the figure. For example, it can be implemented as a cellular telephone 1080. It can also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for the management of data, the system comprising:
one or more processors; and
computer-readable memory storing instructions that, when executed by the processors, cause the processors to perform operations comprising:
receiving order data that specifies one or more items to be purchased from one or more source locations in a supply chain for a destination location;
receiving one or more constraints for the order in the supply chain;
determining, for each item and based on the constraints, a travel path for the item to reach the destination location, the travel path defining a plurality of facilities and a plurality of travel legs that together define a travel path for the item to be shipped from a source location to a destination location;
selecting one or more milestones for the travel path based on the constraints;
selecting one or more other milestones for the travel path based on the constraints;
wherein one of the milestones is an inventory readiness date that specifies a first calendar date on which an order of items should be ready at each items' respective destination location.

2. The system of claim 1, wherein the supply chain is organized into at least two arms, and wherein determining, for each item and based on the constraints, a travel path for the item comprises selecting one of the arms based on the constraints.

3. The system of claim 1, wherein one of the constraints is a date upon which a supplier will supply an item to the supply chain.

4. The system of claim 1, wherein one of the constraints is a date to be used as the inventory readiness date.

5. The system of claim 1, wherein the travel path is determined to optimize cost, given the constraints.

6. The system of claim 1, wherein the travel path is determined to optimize time, given the constraints.

7. The system of claim 1, wherein the operations further comprise:
determining a processing duration for each facility in the item's travel path to reflect a length of time that the facility is expected to require to process the item;
determining a travel duration for each travel leg in the item's travel path to reflect a length of time that the item is expected to travel along the travel leg;
generating an inventory readiness metric based on the item's travel based on tracking data for the item as the item travels from the item's respective source location to the respective destination location.

8. The system of claim 7, wherein the operations further comprise:
adjusting a particular travel duration of a particular travel leg after the particular travel duration is determined; and
responsive to adjusting the particular travel duration, adjusting a particular departure date of the particular travel leg.

9. The system of claim 8, wherein adjusting the particular travel duration is performed based on a record of historical performance of a shipper associated with the particular travel leg.

10. The system of claim 8, wherein adjusting the particular travel duration is performed based on a travel event scheduled to occur along the particular travel leg between the particular departure date of the particular travel leg and a particular arrival date of the particular travel leg.

11. The system of claim 10, wherein the travel event is a weather event.

12. The system of claim 11, wherein the travel event is a traffic event.

13. The system of claim 7, wherein the operations further comprise:
adjusting a particular processing duration of a particular facility after the particular process duration is determined; and
responsive to adjusting the particular processing duration, adjusting a particular arrival date of a preceding travel leg.

14. The system of claim 13, wherein adjusting the processing duration comprises is performed based on a record of historical performance of the particular facility.

15. The system of claim 13, wherein adjusting the processing duration comprises is performed based on a processing event scheduled to occur in the particular facility.

16. The system of claim 15, wherein the processing event is a work-stop event due to a holiday or a weekend.

17. The system of claim 15, wherein the processing event is a capital improvement in the facility that increases the productivity of the facility.

18. A method for the management of data, the method comprising:
receiving order data that specifies one or more items to be purchased from one or more source locations in a supply chain for a destination location;
receiving one or more constraints for the order in the supply chain;
determining, for each item and based on the constraints, a travel path for the item to reach the destination location, the travel path defining a plurality of facilities and a plurality of travel legs that together define a travel path for the item to be shipped from a source location to a destination location;
selecting one or more milestones for the travel path based on the constraints;
selecting one or more other milestones for the travel path based on the constraints;
wherein one of the milestones is an inventory readiness date that specifies a first calendar date on which an order of items should be ready at each items' respective destination location.
